(19) United States
(12) Patent Application Publication
(10) Pub. No.: US 2021/0350783 A1
(43) Pub. Date: Nov. 11, 2021

(54) SOUND SIGNAL SYNTHESIS METHOD, NEURAL NETWORK TRAINING METHOD, AND SOUND SYNTHESIZER

(71) Applicant: Yamaha Corporation, Hamamatsu (JP)

(72) Inventor: Ryunosuke DAIDO, Hamamatsu (JP)

(21) Appl. No.: 17/381,009

(22) Filed: Jul. 20, 2021

Related U.S. Application Data
(63) Continuation of application No. PCT/JP2020/003526, filed on Jan. 30, 2020.

(30) Foreign Application Priority Data
Feb. 1, 2019 (JP) 2019-017242
Feb. 20, 2019 (JP) 2019-028453

(51) Int. Cl. G10L 13/00; G10L 25/30; G10H 7/00

(52) U.S. Cl. CPC G10L 13/00; G10H 2250/311; G10H 7/002; G10L 25/30

(57) ABSTRACT

A sound signal synthesis method includes inputting control data representing conditions of a sound signal into a neural network, and thereby estimating first data representing a deterministic component of the sound signal and second data representing a stochastic component of the sound signal, and combining the deterministic component represented by the first data and the stochastic component represented by the second data, and thereby generating the sound signal. The neural network has learned a relationship between control data that represents conditions of a sound signal of a reference signal, a deterministic component of the sound signal of the reference signal, and a stochastic component of the sound signal of the reference signal.

### CROSS-REFERENCE TO RELATED APPLICATIONS

This application is a continuation application of International Application No. PCT/JP2020/003526, filed on Jan. 30, 2020, which claims priority to Japanese Patent Application No. 2019-017242 filed in Japan on Feb. 1, 2019 and Japanese Patent Application No. 2019-028453 filed in Japan on Feb. 20, 2019. The entire disclosures of International Application No. PCT/JP2020/003526 and Japanese Patent Application Nos. 2019-017242 and 2019-028453 are hereby incorporated herein by reference.

### BACKGROUND

### Technical Field

This disclosure relates to a technology for synthesizing sound signals.

### Background Information

For example, sounds such as voice, musical sounds, and the like, usually contain components that are commonly included in each sound generated by a sound generator, when sound generation conditions such as pitch and tone are the same (hereinafter referred to as the “deterministic component”), as well as non-periodic components that change randomly for each generated sound (hereinafter referred to as the “stochastic component”). The stochastic component is generated due to stochastic factors in the process of sound generation. Examples of the stochastic components include components of the voice generated produced by turbulence in the air inside the human speech organ, components of musical sounds of bowed string instruments generated due to friction between the bow and the strings, etc.

Examples of sound generators that synthesize sound include an additive synthesis sound generator that synthesizes sound by adding a plurality of sinusoidal waves, an FM sound generator that synthesizes sound by FM modulation, and a waveform table sound generator that reads recorded waveforms from a table to generate sound, a modeling sound generator that synthesizes sound by modeling natural musical instruments and electric circuits, and the like. Although conventional sound generators can synthesize deterministic components of sound signals of high quality, no consideration is given to their reproduction of the stochastic components, and thus such sound generators cannot generate stochastic components of high quality. Although various noise sound generators as described in Japanese Laid-Open Patent Publication No. H4-77793 and Japanese Laid-Open Patent Publication No. H4-181996 have also been proposed, the reproducibility of the intensity distribution of the stochastic components was low, so that an improvement in the quality of generated sound signals is desired.

On the other hand, sound synthesis technology (hereinafter referred to as a “stochastic neural vocoder”) for using a neural network to generate sound waveforms in accordance with conditional inputs has been proposed, as in U.S. Patent Application Publication No. 2018/0322891. The stochastic neural vocoder estimates the probability density distribution for a sample of a sound signal, or parameters that represent it, at each time step. The final sound signal sample is set by generating a pseudo-random number corresponding to the estimated probability density distribution.

### SUMMARY

The stochastic neural vocoder can estimate the probability density distribution of stochastic components with high accuracy, and can synthesize stochastic components of sound signals with relatively high quality, but it is not good at generating deterministic components with less noise. Therefore, deterministic components generated by the stochastic neural vocoder tend to be signals that contain noise. In consideration of such circumstances, an object of this disclosure is the synthesis of sound signals with high quality.

A sound signal synthesis method according to the present disclosure comprises inputting control data representing conditions of a sound signal into a neural network, and thereby estimating first data representing a deterministic component of the sound signal and second data representing a stochastic component of the sound signal, and combining the deterministic component represented by the first data and the stochastic component represented by the second data, and thereby generating the sound signal. The neural network has learned a relationship between control data that represents conditions of a sound signal of a reference signal, a deterministic component of the sound signal of the reference signal, and a stochastic component of the sound signal of the reference signal.

A neural network training method according to the present disclosure comprises acquiring a deterministic component and a stochastic component of a reference signal, acquiring control data corresponding to the reference signal, and training a neural network to estimate first data indicating the deterministic component and second data indicating the stochastic component in accordance with the control data.

### BRIEF DESCRIPTION OF THE DRAWINGS

FIG. 1 is a block diagram illustrating a hardware configuration of a sound synthesizer.

FIG. 2 is a block diagram illustrating a functional configuration of the sound synthesizer.

FIG. 3 is an explanatory diagram of a processing of a training module.

FIG. 4 is a flowchart of a processing of the training module.

FIG. 5 is a flowchart of a preparation process.

FIG. 6 is an explanatory diagram of a processing of a generation module.

FIG. 7 is a flowchart of a sound generation process.

FIG. 8 is an explanatory diagram of another example of the generation module.

FIG. 9 is a flowchart of a sound generation process.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

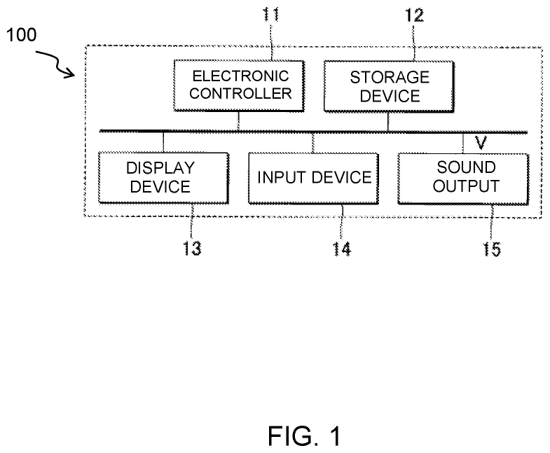

FIG. 1 is a block diagram illustrating the hardware configuration of a sound synthesizer 100. The sound synthesizer 100 is a computer system comprising an electronic controller (control device) 11, a storage device (computer memory) 12, a display device (display) 13, an input device (user operable input) 14, and a sound output device 15. The sound synthesizer 100 is an information terminal such as a mobile phone, a smartphone, or a personal computer.

The electronic controller 11 includes one or more processors and controls each element constituting the sound synthesizer 100. The term “electronic controller” as used herein refers to hardware that executes software programs. The electronic controller 11 is configured to comprise one or more processors, such as a CPU (Central Processing Unit), an SPU (Sound Processing Unit), a DSP (Digital Signal Processor), an FPGA (Field Programmable Gate Array), an ASIC (Application Specific Integrated Circuit), etc. The electronic controller 11 generates a time-domain sound signal V that represents the synthesized sound waveform.

The storage device 12 includes one or more memory units for storing a program that is executed by the electronic controller 11 and various data that are used by the electronic controller 11. A known storage medium, such as a magnetic storage medium or a semiconductor storage medium, or a combination of a plurality of various types of storage media constitute the storage device 12. The storage device 12 can be any computer storage device or any computer readable medium with the sole exception of a transitory, propagating signal. Moreover, a storage device 12 that is separate from the sound synthesizer 100 (for example, cloud storage) can be prepared, and the electronic controller 11 can read from or write to the storage device 12 via a communication network, such as a mobile communication network or the Internet. That is, the storage device 12 can be omitted from the sound synthesizer 100.

The display device 13 displays the results of calculations executed by the electronic controller 11. The display device 13 is a liquid-crystal display panel, or an organic electroluminescent display, for example. The display device 13 can be omitted from the sound synthesizer 100.

The input device 14 receives input from a user. The input device 14 is a touch panel, a button, a switch, a lever, and/or a dial, for example. The input device 14 can be omitted from the sound synthesizer 100.

The sound output device 15 reproduces the sound represented by the sound signal V generated by the electronic controller 11. The sound output device 15 is a speaker and/or headphones, for example. Illustrations of a D/A converter that converts the sound signal V from digital to analog and of an amplifier that amplifies the sound signal V have been omitted for the sake of clarity. A configuration in which the sound synthesizer 100 is provided with the sound output device 15 is illustrated in FIG. 1; however, a sound output device 15 that is separate from the sound synthesizer 100 can be connected to the sound synthesizer 100 by wire or wirelessly.

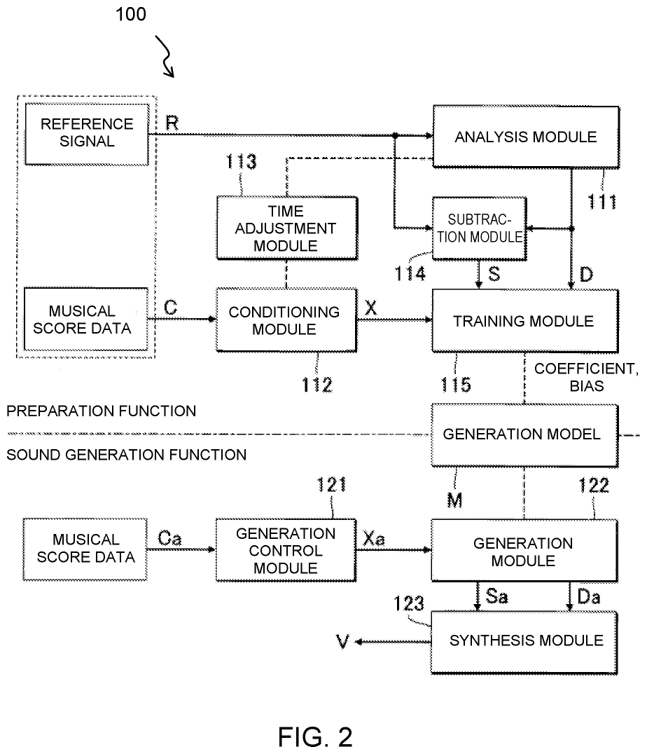

FIG. 2 is a block diagram illustrating the functional configuration of the sound synthesizer 100. The electronic controller 11 realizes a preparation function for preparing a generation model M used for the generation of the sound signal V, by the execution of a first program module that is stored in the storage device 12. More specifically, the electronic controller 11 executes a plurality of modules including an analysis module 111, a conditioning module 112, a time adjustment module 113, a subtraction module 114, and a training module 115 to realize the preparation function. In addition, the electronic controller 11 realizes a sound generation function for generating the time-domain sound signal V representing a waveform of sound such as a singing sound of a singer or a performing sound of a musical instrument, by execution of a second program module including the generation model M that is stored in the storage device 12. More specifically, the electronic controller 11 executes a plurality of modules including a generation control module 121, a generation module 122, and a synthesis module 123 to realize the sound generation function. The functions of the electronic controller 11 can be realized by a collection of a plurality of devices (that is, a system), or, some or all of the functions of the electronic controller 11 can be realized by a dedicated electronic circuit (such as a signal processing circuit).

First, the generation model M and data used for its training will be described.

The generation model M is a statistical model for generating a time series of a deterministic component Da and a time series of a stochastic component Sa of a sound signal V, in accordance with control data Xa that specify (represent) the conditions of the sound signal V to be synthesized. The characteristics of the generation model M (specifically, the relationship between input and output) are defined by a plurality of variables (for example, coefficients, biases) that are stored in the storage device 12.

The deterministic component Da, D (definitive component) is an acoustic component that is equally included in each sound generated by a sound generator, when sound generation conditions such as pitch and tone are the same. It can also be said that the deterministic component Da, D is an acoustic component that predominantly contains harmonic components (that is, periodic components) in comparison with non-harmonic components. For example, the deterministic component Da, D is a periodic component derived from the regular vibrations of vocal cords that produce speech. The stochastic component Sa, S (probability component), on the other hand, is a non-periodic acoustic component that is generated due to stochastic factors in the process of sound generation. For example, the stochastic component Sa, S includes a component of voice generated due to the turbulence of air inside the human speech organ, and/or a component of musical sounds of bowed string instruments generated due to the friction between the bow and the strings. It can also be said that the stochastic component Sa, S is an acoustic component that predominantly contains non-harmonic components in comparison with harmonic components. Further, the deterministic component Da, D can be expressed as a regular acoustic component that has periodicity, and the stochastic component Sa, S can be expressed as an irregular acoustic component that is stochastically generated.

The generation model M is a neural network that estimates the first data representing the deterministic component Da and the second data representing the stochastic component Sa in parallel. The first data represent a sample (that is, one component value) of the deterministic component Da. The second data represent a probability density distribution of the stochastic component Sa. The probability density distribution can be expressed by a probability density value corresponding to each value of the stochastic component Sa, or by the mean and variance of the stochastic component Sa. The neural network can be a recursive type in which the probability density distribution of the current sample is estimated based on a plurality of past samples of the sound signal, such as WaveNet. In addition, the neural network can be a CNN (Convolutional Neural Network), RNN (Recurrent Neural Network), or a combination thereof. Furthermore, the neural network can be a type with additive elements such as LSTM (Long Short-Term Memory) or ATTENTION. The plurality of variables of the generation model M are established by the preparation function that includes training using training data. The generation model M for which the variables have been established is used for generating the deterministic component Da and the stochastic component Sa of the sound signal V by the sound generation function described further below.

The storage device 12 stores a plurality of sets of musical score data C and reference signal R for training the generation model M. The musical score data C represent the musical score (that is, a time series of notes) of all or part of the musical piece. For example, time-series data specifying the pitch and pronunciation period for each note are utilized as the musical score data C. When singing sounds are synthesized, the musical score data C also specify the phonemes (for example, phonetic characters) for each note.

The reference signal R corresponding to each piece of musical score data C represents the waveform of the sound generated by performing the musical score represented by the musical score data C. Specifically, the reference signal R represents a time series of partial waveforms corresponding to the time series of the notes represented by the musical score data C. Each reference signal R is formed of a time series of samples for each sampling period (for example, 48 kHz) and is a time-domain signal that represents a sound waveform including a deterministic component D and a stochastic component S. The performance for recording the reference signal R is not limited to the performance of a musical instrument by a human being, and can be a song sung by a singer or the automatic performance of a musical instrument. In order to generate the generation model M that can generate a high-quality sound signal V by machine learning, a sufficient amount of training data is generally required. Accordingly, a large number of performance sound signals for a large number of musical instruments or performers are recorded in advance and stored in the storage device 12 as the reference signal R.

The preparation function will be described. The analysis module 111 calculates the deterministic component D from the time series of the spectrum in the frequency domain for each of the plurality of reference signals R respectively corresponding to a plurality of musical scores. A known frequency analysis such as Discrete Fourier Transform is used for the calculation of the spectrum of the reference signal R. The analysis module 111 extracts the locus of the harmonic component from a time series of the spectrum of the reference signal R as a time series of the spectrum (hereinafter referred to as “deterministic spectrum”) of the deterministic component D, and generates the deterministic component D of the time domain from the time series of the deterministic spectrum.

The time adjustment module 113 adjusts the start time point and the end time point of each pronunciation unit in the musical score data C corresponding to each reference signal R to respectively match the start time point and the end time point of the partial waveform corresponding to the pronunciation unit in the reference signal R, based on a time series of the deterministic spectrum. That is, the time adjustment module 113 specifies a partial waveform corresponding to each pronunciation unit of the reference signal R designated by the musical score data C. Here, the pronunciation unit is, for example, one note defined by the pitch and the pronunciation period. One note can be divided into a plurality of pronunciation units by dividing at time points at which the characteristics of the waveform, such as the tone, change.

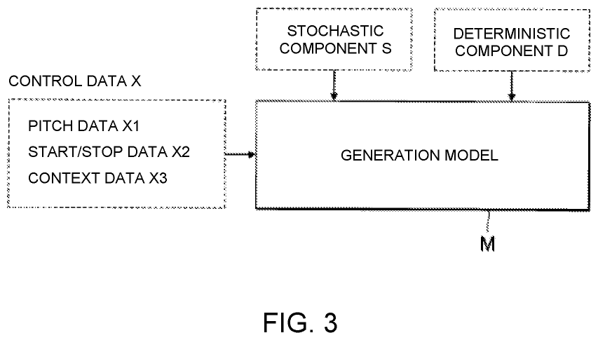

Based on information of each pronunciation unit of the musical score data C in which time is arranged for each reference signal R, the conditioning module 112 generates, and outputs to the training module 115, control data X corresponding to each partial waveform of the reference signal R. The control data X represent conditions of the sound signal V, and are generated for each pronunciation unit. As illustrated in FIG. 3, the control data X include, for example, pitch data X1, start/stop data (start and stop data) X2, and context data X3. The pitch data X1 specify the pitch of the partial waveform. The pitch data X1 can include changes in pitch caused by pitch bend or vibrato. The start/stop data X2 specify the start period (attack) and end period (release) of the partial waveform. The context data X3 specify the relationship with one or more pronunciation units before and after, such as the pitch difference with the notes before and after. The control data X can further include other information, such as musical instruments, singers, playing styles, etc. When singing sounds are synthesized, the context data X3 specify the phoneme expressed by phonetic characters, for example.

The subtraction module 114 of FIG. 2 generates the stochastic component S in the time domain by subtracting the deterministic component D of each reference signal R from each reference signal R. The deterministic spectrum, the deterministic component D, and the stochastic component S of the reference signal R are obtained by the processing of each functional module up to this point.

Thus, training data (hereinafter referred to as “unit data”) of the generation model M are obtained for each pronunciation unit utilizing a plurality of sets of the reference signal R and the musical score data C. Each piece of unit data is a set of the control data X, the deterministic component D, and the stochastic component S. Prior to training by the first training module 115, the plurality of pieces of the unit data are divided into training data for training the generation model M and test data for testing the generation model M. Most of the plurality of pieces of the unit data are selected as the training data, and some are selected as the test data. With regard to the training by the training data, a plurality of pieces of training data are divided into batches for each prescribed number, and the batches are sequentially executed one by one for all of the batches. As can be understood from the foregoing explanation, the analysis module 111, the conditioning module 112, the time adjustment module 113, and the subtraction module 114 function as a preprocessing module for generating the plurality of pieces of training data.

The training module 115 acquires the deterministic component D of the reference signal R and the stochastic component S of the reference signal R, acquires the control data X corresponding to the reference signal R, and trains the generation model M (neural network) to estimate the first data indicating the deterministic component D and the second data indicating the stochastic component S in accordance with the control data X. The training module 115 uses a plurality of pieces of training data to train the generation model M. Specifically, the training module 115 receives a prescribed number of pieces of training data for each batch, and uses the deterministic component D, the stochastic component S, and the control data X in each of the plurality of pieces of training data included in the batch to train the generation model M.

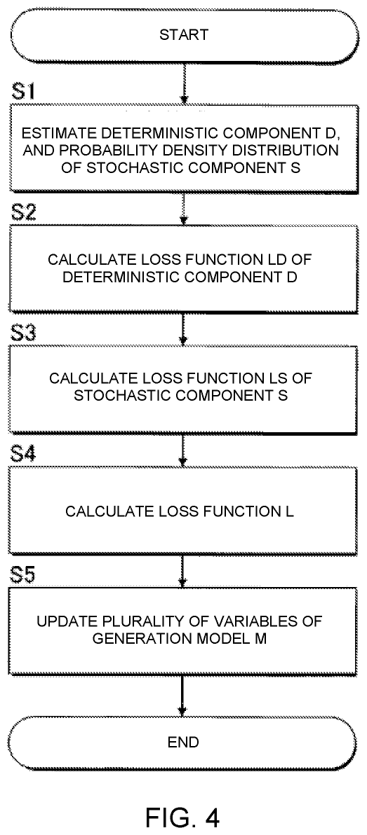

FIG. 3 is a diagram explaining the processing of the training module 115, and FIG. 4 is a flowchart showing a specific procedure of the process executed by the training module 115 for each batch. The deterministic component D and the stochastic component S of each pronunciation unit are generated from the same partial waveform.

The training module 115 sequentially inputs the control data X included in each piece of training data of one batch into the tentative generation model M and thereby estimates the deterministic component D (one example of the first data) and the probability density distribution of the stochastic component S (one example of the second data) for each piece of training data (S1).

The training module 115 calculates a loss function LD of the deterministic component D (S2). The loss function LD is a numerical value obtained by accumulating the loss function representing the difference between the deterministic component D estimated by the generation model M from each piece of training data and the deterministic component D included in the aforementioned training data (that is, the correct answer value), for the plurality of pieces of training data in a batch. The loss function between the deterministic components D is 2 norms, for example.

The training module 115 calculates a loss function LS of the stochastic component S (S3). The loss function LS is a numerical value obtained by accumulating the loss function of the stochastic component S for the plurality of pieces of training data in a batch. The loss function of the stochastic component S is, for example, a numerical value obtained by inverting the sign of the logarithmic likelihood of the stochastic component S (that is, the correct answer value) in the training data, with respect to the probability density distribution of the stochastic component S estimated by the generation model M from each piece of the training data. The order of the calculation of the loss function LD (S2) and the calculation of the loss function LS (S3) can be reversed.

The training module 115 calculates the loss function L from the loss function LD of the deterministic component D and the loss function LS of the stochastic component S (S4). For example, a weighted sum of the loss function LD and the loss function LS is calculated as the loss function L. The training module 115 updates the plurality of variables of the generation model M such that the loss function L is decreased (S5).

The training module 115 repeats the above-described training (S1-S5) that uses the prescribed number of pieces of training data of each batch until a prescribed termination condition is satisfied. The termination condition is, for example, the value of the loss function L calculated for the above-described test data becoming sufficiently small, or changes in the loss function L between successive trainings becoming sufficiently small.

The generation model M established in this manner has learned the latent relationship between the control data X, and the deterministic component D and the stochastic component S in the plurality of pieces of training data. By this sound generation function using the generation model M, a high-quality deterministic component Da and stochastic component Sa that correspond to each other temporally can be generated in parallel, even for unknown control data Xa.

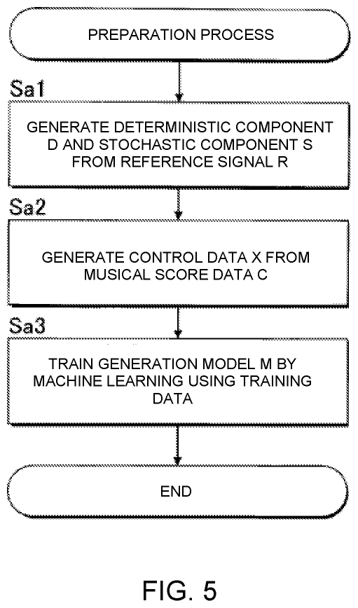

FIG. 5 is a flowchart of the preparation process. The preparation process is started, for example, in response to an instruction from a user of the sound synthesizer 100.

When the preparation process is started, the electronic controller 11 (the analysis module 111 and the subtraction module 114) generates (estimates) the deterministic component D and the stochastic component S from each of the plurality of reference signals R (Sal). The electronic controller 11 (the conditioning module 112 and the time adjustment module 113) generates the control data X from the musical score data C (Sa2). That is, training data including the control data X, the deterministic component D, and the stochastic component S are generated for each partial waveform of the reference signal R. The electronic controller 11 (the training module 115) trains the generation model M by machine learning using the plurality of pieces of training data (Sa3). The specific procedure for training the generation model M (Sa3) is as described above with reference to FIG. 4.

The sound generation function for generating the sound signal V using the generation model M prepared by the preparation function will now be described. The sound generation function is a function for generating the sound signal V using musical score data Ca as input. The musical score data Ca are time-series data that specify the time series of notes that constitute all or part of the musical score, for example. When the sound signal V of singing sounds is synthesized, the phoneme for each note is designated by the musical score data Ca. The musical score data Ca represent a musical score edited by a user using the input device 14, while referring to an editing screen displayed on the display device 13, for example. The musical score data Ca received from an external device via a communication network can be used as well.

The generation control module 121 of FIG. 2 generates the control data Xa based on the information on a series of pronunciation units of the musical score data Ca. The control data Xa include the pitch data X1, the start/stop data (start and stop data) X2, and the context data X3 for each pronunciation unit specified by the musical score data Ca. As explained above, the pitch data X1 specify the pitch of the partial waveform. The pitch data X1 can include changes in pitch caused by pitch bend or vibrato. The start/stop data X2 specify the start period (attack) and end period (release) of the partial waveform. The context data X3 specify the relationship with one or more pronunciation units before and after, such as the pitch difference with the notes before and after. The control data X can further include other information, such as musical instruments, singers, playing styles, etc. The control data Xa can further include other information, such as musical instruments, singers, playing styles, etc.

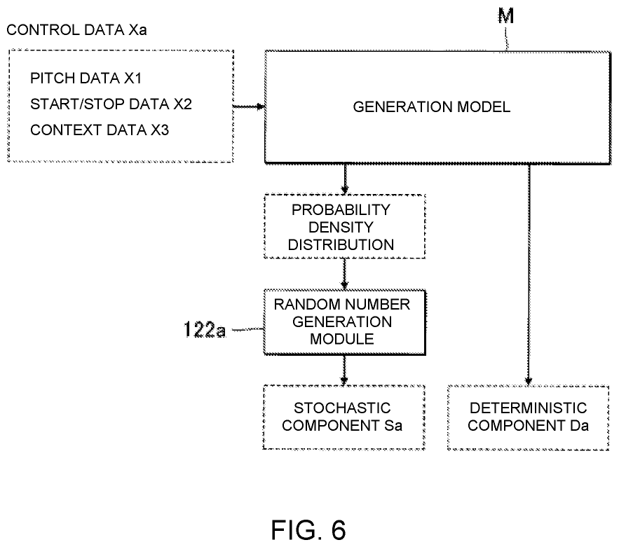

The generation module 122 inputs the control data Xa into the generation model M, and thereby estimates the first data representing the deterministic component Da of the sound signal V and the second data representing the stochastic component Sa of the sound signal V. The generation module 122 uses the generation model M to generate a time series of the deterministic component Da and a time series of the stochastic component Sa in accordance with the control data Xa. FIG. 6 is a diagram illustrating the processing of the generation module 122. The generation module 122 uses the generation model M and estimate, in parallel, the deterministic component Da (one example of the first data) corresponding to the control data Xa and the probability density distribution (one example of the second data) of the stochastic component Sa corresponding to the control data Xa for each sampling period.

The generation module 122 includes a random number generation module (first random number generation module) 122a. The random number generation module 122a generates a random number (first random number) in accordance with the probability density distribution of the stochastic component Sa, and outputs the value as the stochastic component Sa of that sampling period. As described above, the time series of the deterministic component Da and the time series of the stochastic component Sa generated in this manner correspond to each other temporally. That is, the deterministic component Da and the stochastic component Sa are samples at the same time point in the synthesized sound.

The synthesis module 123 combines the deterministic component Da represented by the first data and the stochastic component Sa represented by the second data, and thereby generates the sound signal V. More specifically, the synthesis module 123 combines the deterministic component Da and the stochastic component Sa and thereby synthesizes a time series of the samples of the sound signal V. For example, the synthesis module 123 adds the deterministic component Da and the stochastic component Sa, thereby synthesizing a time series of the samples of the sound signal V.

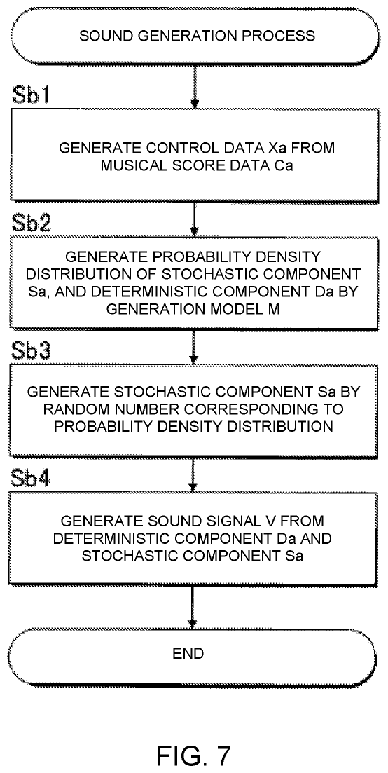

FIG. 7 is a flowchart of a process (hereinafter referred to as “sound generation process”) by which the electronic controller 11 generates the sound signal V from the musical score data Ca. The sound generation process is started, for example, in response to an instruction from a user of the sound synthesizer 100.

When the sound generation process is started, the electronic controller 11 (generation control module 121) generates the control data Xa for each pronunciation unit from the musical score data Ca (Sb1). The electronic controller 11 (generation module 122) inputs the control data Xa into the generation model M and thereby estimates (generates) the deterministic component Da, and the probability density distribution of the stochastic component Sa (Sb2). The electronic controller 11 (generation module 122) then generates the stochastic component Sa in accordance with the probability density distribution of the stochastic component Sa (Sb3). More specifically, the electronic controller 11 (random number generation module 122a) generates a random number in accordance with the probability density distribution of the stochastic component Sa. The electronic controller 11 (synthesis module 123) combines the deterministic component Da and the stochastic component Sa and thereby generates the sound signal V (Sb4).

As described above, in the first embodiment, the control data Xa are input into the generation model M that has learned the relationship between the control data X representing the conditions of a sound signal and the deterministic component D and the stochastic component S of the sound signal, and thereby estimates (generates) the deterministic component Da and the stochastic component Sa of the sound signal V. Thus, a high-quality sound signal V that includes the deterministic component Da and the stochastic component Sa that is suitable for the deterministic component Da can be generated. Specifically, for example, compared to the technology of Japanese Laid-Open Patent Publication No. H4-77793 or Japanese Laid-Open Patent Publication No. H4-181996, the high-quality sound signal V is generated, in which the intensity distribution of the stochastic component Sa is faithfully reproduced. In addition, compared to the stochastic neural vocoder of U.S. Patent Application Publication No. 2018/0322891, a deterministic component Da having few noise components is generated. That is, according to the first embodiment, both the deterministic component Da and the stochastic component Sa can generate the high-quality sound signal V.

### B: Second Embodiment

The second embodiment will be described. In each of the following embodiments, elements that have the same functions as in the first embodiment have been assigned the same reference symbols as those used to describe the first embodiment, and detailed descriptions thereof have been appropriately omitted.

In the first embodiment, the generation model M estimates a sample (one component value) of the deterministic component Da as the first data. The generation model M of the second embodiment estimates the probability density distribution of the deterministic component Da as the first data.

That is, the generation model M is trained by the training module 115 in advance so as to estimate the probability density distribution of the deterministic component Da and the probability density distribution of the stochastic component Sa with respect to input of the control data Xa. Specifically, in Step S2 of FIG. 4, the training module 115 accumulates the loss function of the deterministic component D for a plurality of pieces of training data in a batch and thereby calculates the loss function LD. The loss function of the deterministic component D is, for example, a numerical value obtained by inverting the sign of the logarithmic likelihood of the deterministic component D (that is, the correct answer value) in the training data, with respect to the probability density distribution of the deterministic component D estimated by the generation model M from each piece of the training data. Except for Step S2, the process flow is basically the same as that of the first embodiment.

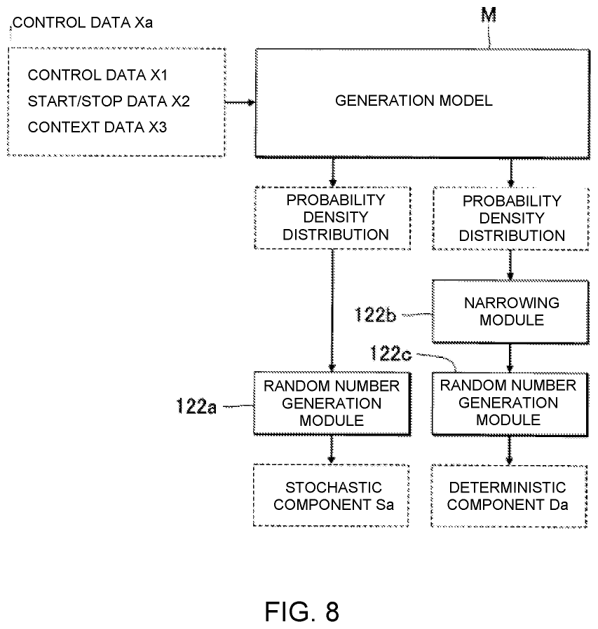

FIG. 8 is an explanatory diagram of the processing of the generation module 122. The portion relating to the generation of the deterministic component Da of the first embodiment illustrated in FIG. 6 has been changed as shown in FIG. 8. The generation model M estimates the probability density distribution of the deterministic component Da (one example of the first data) and the probability density distribution of the stochastic component Sa (one example of the second data), which correspond to the control data Xa.

The generation module 122 includes a narrowing module 122b and a random number generation module (second random number generation module) 122c. The narrowing module 122b reduces the variance of the probability density distribution of the deterministic component Da. For example, when the probability density distribution is defined by a probability density value corresponding to each value of the deterministic component Da, the narrowing module 122b searches for the peak of the probability density distribution, maintains the probability density value at the aforementioned peak, and reduces the probability density value in the range outside the peak. In addition, when the probability density distribution of the deterministic component Da is defined by the mean and variance, the narrowing module 122b reduces the variance to a small value by a certain calculation such as multiplication by a coefficient less than 1. The random number generation module 122c generates a random number (second random number) in accordance with the narrowed probability density distribution and outputs the value as the deterministic component Da in the sampling period.

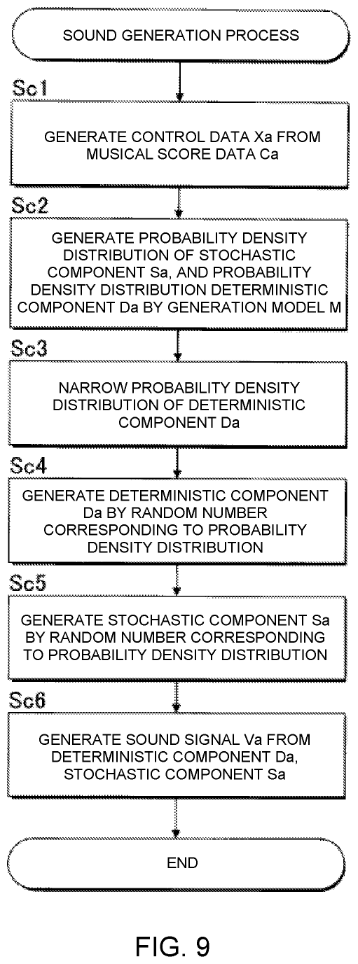

FIG. 9 is a flowchart of the sound generation process. The sound generation process is started, for example, in response to an instruction from a user of the sound synthesizer 100.

When the sound generation process is started, the electronic controller 11 (generation control module 121) generates the control data Xa for each pronunciation unit from the musical score data Ca in the same manner as in the first embodiment (Sc1). The electronic controller 11 (generation module 122) inputs the control data Xa into the generation model M and thereby generates the probability density distribution of the deterministic component Da and the probability density distribution of the stochastic component Sa (Sc2). The electronic controller 11 (generation module 122) narrows the probability density distribution of the deterministic component Da (Sc3). The electronic controller 11 (generation module 122)generates the deterministic component Da from the narrowed probability density distribution (Sc4). More specifically, the electronic controller 11 (random number generation module 122c) generates the random number in accordance with the probability density distribution of the deterministic component Da to estimate the deterministic component Da. In addition, the electronic controller 11 (generation module 122) generates the stochastic component Sa from the probability density distribution of the stochastic component Sa, in the same manner as in the first embodiment (Sc5). The electronic controller 11 (synthesis module 123) combines the deterministic component Da and the stochastic component Sa, and thereby generates the sound signal Va, in the same manner as in the first embodiment (Sc6). The order of the generation of the deterministic component Da (Sc3 and Sc4) and the generation of the stochastic component Sa (Sc5) can be reversed.

The same effects as those of the first embodiment are realized in the second embodiment. Additionally, in the second embodiment, the probability density distribution of the deterministic component Da is narrowed and thereby generates a deterministic component Da with a small noise component. Thus, according to the second embodiment, a high-quality sound signal V in which the noise component of the deterministic component Da is reduced can be generated, as compared with the first embodiment. However, the narrowing (Sc3) of the probability density distribution of the deterministic component Da can be omitted.

### C: Modification

Specific modified embodiments to be added to each of the foregoing embodiments will be illustrated below. Two or more embodiments arbitrarily selected from the following examples can be appropriately combined as long as they are not mutually contradictory.

(1) In the sound generation function of the first embodiment, the sound signal V is generated based on the information on a series of pronunciation units of the musical score data Ca, but the sound signal V can be generated in real time, based on information of pronunciation units supplied from a keyboard, or the like. The generation control module 121 generates the control data Xa for each time point based on the information on the pronunciation units that have been supplied up to that point in time. In that case, the context data X3 included in the control data Xa basically cannot include information on future pronunciation units, but information of future pronunciation units can be predicted from past information, so as to include information of future pronunciation units.

(2) The method for generating the deterministic component D is not limited to a method in which the locus of the harmonic component in the spectrum of the reference signal R is extracted, as described in the embodiments. For example, the phases of partial waveforms of a plurality of pronunciation units corresponding to the same control data X can be aligned by spectral manipulation, or the like, and averaged, and the averaged waveform can be used as the deterministic component D. Alternatively, a pulse waveform corresponding to one period estimated from an amplitude spectrum envelope and a phase spectrum envelope in Jordi Bonada's paper “High quality voice transformations based on modeling radiated voice pulses in frequency domain” (Proc. Digital Audio Effects (DAFx). Vol. 3. 2004.) can be used as the deterministic component D.

(3) In the embodiments described above, the sound synthesizer 100 having both the preparation function and the sound generation function is exemplified, but the preparation function can be provided in a device (hereinafter referred to as “machine learning device”) that is separate from the sound synthesizer 100 having the sound generation function. The machine learning device generates the generation model M by the preparation function illustrated in the embodiments described above. For example, the machine learning device is realized by a server device that can communicate with the sound synthesizer 100. The generation model M trained by the machine learning device is provided in the sound synthesizer 100 and used for the generation of the sound signal V.

(4) In the embodiments described above, the stochastic component Sa is sampled from the probability density distribution generated by the generation model M, but the method for generating the stochastic component Sa is not limited to the example described above. For example, a generation model (for example, neural network) that simulates the above sampling process (that is, the generation process of the stochastic component Sa) can be used for the generation of the stochastic component Sa. Specifically, as in Parallel WaveNet, a generation model that uses the first control data Xa and a random number as inputs and that outputs the component value of the stochastic component Sa is used.

(5) The sound synthesizer 100 can also be realized by a server device that communicates with a terminal device such as a mobile phone or a smartphone. For example, the sound synthesizer 100 uses the generation model M to generate the sound signal V from the musical score data Ca received from the terminal device and transmits the sound signal V to the terminal device. The generation control module 121 can be provided in the terminal device. The sound synthesizer 100 receives the control data Xa generated by the generation control module 121 of the terminal device from said terminal device, and generates, and transmits to the terminal device, the sound signal V corresponding to the control data Xa by the generation model M. As can be understood from the foregoing explanation, the generation control module 121 is omitted from the sound synthesizer 100.

(6) The sound synthesizer 100 according to each of the above-described embodiments is realized by cooperation between a computer (specifically, the electronic controller 11) and a program, as is illustrated in each of the above-described embodiments. The program according to each of the above-described embodiments can be stored on a computer-readable storage medium and installed on a computer. The storage medium is, for example, a non-transitory (non-transitory) storage medium, a good example of which is an optical storage medium, such as a CD-ROM (optical disc), but can include known arbitrary storage medium formats, such as semiconductor storage media and magnetic storage media. Non-transitory storage media include any storage medium that excludes transitory propagating signals and does not exclude volatile storage media. In addition, in a configuration in which a distribution device distributes the program via a communication network, a storage device that stores the program in the distribution device corresponds to the non-transitory storage medium.

What is claimed is:

1. A sound signal synthesis method realized by a computer, the sound signal synthesis method comprising:
inputting control data representing conditions of a sound signal into a neural network, and thereby estimating first data representing a deterministic component of the sound signal and second data representing a stochastic component of the sound signal, the neural network being a neural network that has learned a relationship between control data that represents conditions of a sound signal of a reference signal, a deterministic component of the sound signal of the reference signal, and a stochastic component of the sound signal of the reference signal; and
combining the deterministic component represented by the first data and the stochastic component represented by the second data, and thereby generating the sound signal.

2. The sound signal synthesis method according to claim 1, wherein
the generating of the sound signal is performed by adding the deterministic component represented by the first data and the stochastic component represented by the second data.

3. The sound signal synthesis method according to claim 1, wherein
the second data indicate a probability density distribution of the stochastic component,
the sound signal synthesis method further comprises generating a first random number in accordance with the probability density distribution of the stochastic component to estimate the stochastic component, and
the generating of the sound signal is performed by combining the deterministic component represented by the first data and the stochastic component estimated by the generating of the first random number.

4. The sound signal synthesis method according to claim 1, wherein
the first data indicate a component value of the deterministic component.

5. The sound signal synthesis method according to claim 3, wherein
the first data indicate a component value of the deterministic component.

6. The sound signal synthesis method according to claim 1, wherein
the first data indicate a probability density distribution of the deterministic component,
the sound signal synthesis method further comprises generating a second random number in accordance with the probability density distribution of the deterministic component to estimate the deterministic component, and
the generating of the sound signal is performed by combining the deterministic component estimated by the generating of the second random number and the stochastic component represented by the second data.

7. The sound signal synthesis method according to claim 1, wherein
the first data indicate a probability density distribution of the deterministic component,
the second data indicate a probability density distribution of the stochastic component,
the sound signal synthesis method further comprises
generating a first random number in accordance with the probability density distribution of the stochastic component to estimate the stochastic component, and
generating a second random number in accordance with the probability density distribution of the deterministic component to estimate the deterministic component, and
the generating of the sound signal is performed by combining the deterministic component estimated by the generating of the second random number and the stochastic component estimated by the generating of the first random number.

8. A method for training a neural network, the method comprising:
acquiring a deterministic component and a stochastic component of a reference signal;
acquiring control data corresponding to the reference signal; and
training a neural network to estimate first data indicating the deterministic component and second data indicating the stochastic component in accordance with the control data.

9. A sound synthesizer comprising:
an electronic controller including at least one processor, the electronic controller being configured to execute a plurality of modules including
a generation module that inputs control data representing conditions of a sound signal into a neural network, and thereby estimates first data representing a deterministic component of the sound signal and second data representing a stochastic component of the sound signal, the neural network being a neural network that has learned a relationship between control data that represents conditions of a sound signal of a reference signal, a deterministic component of the sound signal of the reference signal, and a stochastic component of the sound signal of the reference signal, and
a synthesis module that combines the deterministic component represented by the first data and the stochastic component represented by the second data, and thereby generating the sound signal.

10. The sound synthesizer according to claim 9, wherein
the synthesis module adds the deterministic component represented by the first data and the stochastic component represented by the second data to generate the sound signal.

11. The sound synthesizer according to claim 9, wherein
the generation module includes a first random number generation module,
the second data indicate a probability density distribution of the stochastic component,
the first random number generation module generates a first random number in accordance with the probability density distribution of the stochastic component to estimate the stochastic component, and
the synthesis module combines the deterministic component represented by the first data and the stochastic component estimated by generation of the first random number.

12. The sound synthesizer according to claim 9, wherein
the first data indicate a component value of the deterministic component.

13. The sound synthesizer according to claim 11, wherein
the first data indicate a component value of the deterministic component.

14. The sound synthesizer according to claim 9, wherein
the generation module includes a second random number generation module,
the first data indicate a probability density distribution of the deterministic component,
the second random number generation module generates a second random number in accordance with the probability density distribution of the deterministic component to estimate the deterministic component, and
the synthesis module combines the deterministic component estimated by the generation of the second random number and the stochastic component represented by the second data.

15. The sound synthesizer according to claim 9, wherein
the first data indicate a probability density distribution of the deterministic component,
the second data indicate a probability density distribution of the stochastic component,
the generation module includes
a first random number generation module that generates a first random number in accordance with the probability density distribution of the stochastic component to estimate the stochastic component, and
a second random number generation module that generates a second random number in accordance with the probability density distribution of the deterministic component to estimate the deterministic component, and
the synthesis module combines the deterministic component estimated by generation of the second random number and the stochastic component estimated by generation of the first random number.

16. The sound synthesizer according to claim 9, wherein
the electronic controller is further configured to execute a training module that trains the neural network using the control data that represents conditions of the sound signal of a reference signal, the deterministic component of the sound signal of the reference signal, and the stochastic component of the sound signal of the reference signal.
